(19) United States
(12) Patent Application Publication
(10) Pub. No.: US 2013/0154771 A1
(43) Pub. Date: Jun. 20, 2013

(54) BAND PASS FILTER

(71) Applicant: KOREA ELECTRONICS TECHNOLOGY INSTITUTE, Seongnam-si (KR)

(72) Inventors: Jin Sup KIM, Seongnam-si (KR); Gyu Bok Lee, Seongnam-si (KR)

(73) Assignee: KOREA ELECTRONICS TECHNOLOGY INSTITUTE, Seongnam-si (KR)

(21) Appl. No.: 13/714,781

(22) Filed: Dec. 14, 2012

(30) Foreign Application Priority Data
Dec. 19, 2011 (KR) 10-2011-0136995

(51) Int. Cl. H01P 1/203

(52) U.S. Cl. CPC H01P 1/203
USPC 333/204

(57) ABSTRACT

A band pass filter is provided. The band pass filter includes a first resonator which includes a first pattern and first microstrip line; a second resonator which includes a second pattern and second microstrip line; a third pattern vertically arranged between the first pattern and second pattern; and a ground pattern connected with the third pattern, embodying a band pass filter using a resonator having a length of 1/16 wavelength or less, instead of a resonator having a length of ¼ wavelength.

### BACKGROUND OF THE INVENTION

1. Field of the Invention

Methods and apparatuses consistent with the exemplary embodiments relate to a band pass filter, and more particularly to a band pass filter which uses a resonator having a length of 1/16 wavelength or less.

2. Background Art

Recently, wireless communication technologies are being applied to electronic devices of various fields, and conventional wired communication technologies are being replaced by wireless communication. Accordingly, various wireless communication technologies such as Ultra Wide Band (UWB), Wireless LAN, Zigbee, and Bluetooth etc. have been developed, and the performance of wireless devices used in wireless communication technologies are developing at a rapid pace.

Along with the accelerated development of wireless communication technologies and performances, wireless communication devices are also becoming smaller and lighter at a rapid pace.

However, as the wireless communication systems and their performances increase, the communication interruptions between wireless devices and noise of wavelength sources which cause interruption are also increasing.

Accordingly, there is needed resistance against noise or harmonic waves in the devices forming wireless communication systems.

In response to these needs, the importance of balanced signal elements such as amplifiers or mixers which use balanced signals easy to remove noise and harmonic waves and filters (wave filters) which filter subharmonic/harmonic wave signals besides the signals of target frequency is increasing, and thus there is a need to design efficient broadband filters.

A conventional band pass filter (BPR) uses a ¼ wavelength resonator. Due to the ¼ wavelength resonator, in a conventional band pass filter, the spurious pass broadband generated from the frequency which is three times the base frequency.

As such, there are much researches being conducted on band pass filters using SIR (Step Impedance Resonator), but band pass filters tend to have a staircase impedance structure where, as the difference of impedance gets bigger, the rejection band gets wider. As such, conventional band pass filters have limitations in obtaining maximum rejection band characteristics

Therefore, there is a need to develop broadband filters which can be designed and embodied in a short time, and which have excellent performances in terms of characteristics and size.

### SUMMARY OF THE INVENTION

The present disclosure has been presented to resolve the aforementioned problems, and the purpose of the present disclosure is to provide a first resonator which includes a first pattern and first microstrip line, a second resonator which includes a second pattern and second microstrip line, a third pattern vertically arranged between the first pattern and second pattern, and a ground pattern connected with the third pattern.

According to an exemplary embodiment of the present disclosure, there is provided a band pass filter which includes a first resonator which includes a first pattern and first microstrip line; a second resonator which includes a second pattern and second microstrip line; a third pattern vertically arranged between the first pattern and second pattern; and a ground pattern connected with the third pattern.

In addition, the first resonator may be formed in such a manner that the first microstrip line is arranged so that a partial area is overlapped at a certain distance on the first pattern.

Furthermore, the partial area which overlaps with the first pattern of the first microstrip line may generate a first inductance, a first capacitance may be generated between the first microstrip line and first pattern, the first pattern may generate a second inductance, and a resonator may be formed by the first inductance, first capacitance, and second inductance.

In addition, the second resonator may be formed in such a manner that the second microstrip line is arranged so that a partial area is overlapped at a certain distance on the second pattern.

Furthermore, the partial area which overlaps with the second pattern of the second microstrip line may generate a third inductance, a second capacitance may be generated between the second microstrip line and second pattern, the second pattern may generate a fourth inductance, and a resonator may be formed by the third inductance, second capacitance, and fourth inductance.

In addition, the third pattern may generate a parallel inductance which magnetically combines the first resonator and second resonator.

Furthermore, each of the first pattern and second pattern may be λ/16 (λ being the wavelength of the transmission signal) long.

Meanwhile, according to an exemplary embodiment of the present disclosure, there is provided a band pass filter which includes a cross pattern formed by horizontal lines and vertical lines crossing each other; a ground pattern which is connected to both ends of the vertical lines of the cross pattern, distanced at a certain distance from the horizontal lines of the cross pattern, and arranged to surround the cross pattern; a first microstrip line arranged at a certain distance from the cross pattern and ground pattern, and arranged to overlap with an end of the horizontal lines of the cross pattern; and a second microstrip line arranged at a certain distance from the cross pattern and ground pattern, and arranged to overlap with the other end of the horizontal lines of the cross pattern.

According to various exemplary embodiments of the present disclosure, it becomes possible to provide a band pass filter which includes a first resonator which includes a first pattern and first microstrip line, second resonator which includes a second pattern and second microstrip line, a third pattern vertically arranged between the first pattern and second pattern, and a ground pattern connected to the third pattern, thereby providing a band pass filter which uses a resonator having a resonator of 1/16 wavelength or less, instead of a ¼ wavelength resonator.

Accordingly, a single impedance structure resonator which has a same impedance makes it easier to embody a band pass filter, and to reduce the size to ½ or less.

### BRIEF DESCRIPTION OF THE DRAWINGS

The above and/or other aspects of the present disclosure will be more apparent by describing certain present disclosure with reference to the accompanying drawings, in which:

FIG. 1A illustrates a plane view of a band pass filter, according to an exemplary embodiment of the present disclosure;

FIG. 1B illustrates a side view of a band pass filter, according to an exemplary embodiment of the present disclosure;

FIG. 2A illustrates a conventional resonator;

FIG. 2B illustrates an equivalent circuit of a resonator used in the band pass filter illustrated in FIGS. 1A and 1B, according to an exemplary embodiment of the present disclosure;

FIG. 3 is a graph comparing frequency characteristics of the resonator of FIGS. 2a and 2b, according to an exemplary embodiment of the present disclosure; and

FIG. 4 is a graph illustrating a result of a simulation for checking the broadband rejection characteristics of a band pass filter, according to an exemplary embodiment of the present disclosure.

### DETAILED DESCRIPTION

Certain exemplary embodiments are described in higher detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

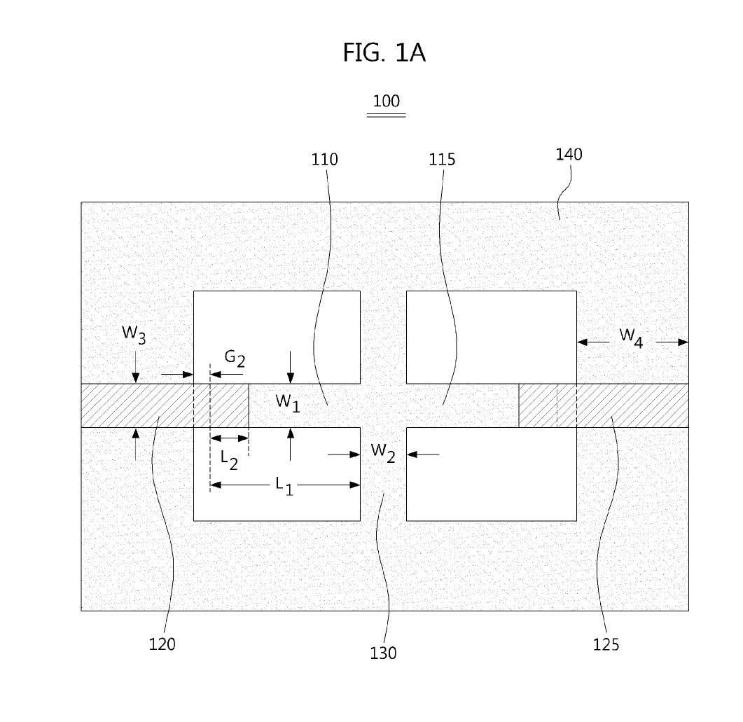

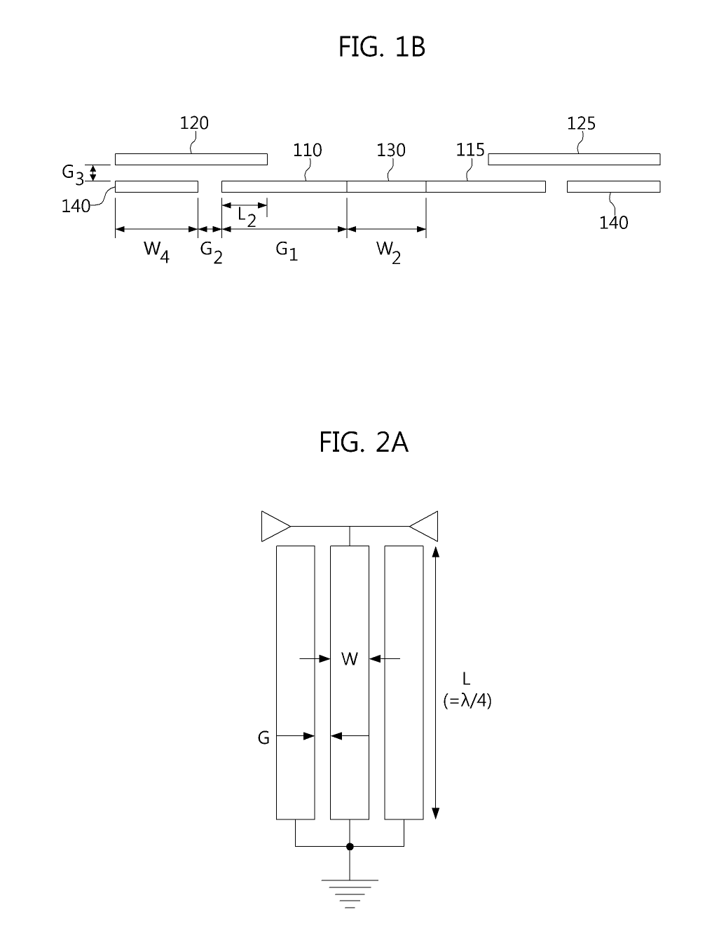

FIG. 1A is a view illustrating a plane view of a band pass filter 100 according to an exemplary embodiment of the present disclosure. In addition, FIG. 1B illustrates a side view of a band pass filter 100 of an exemplary embodiment of the present disclosure.

As illustrated in FIGS. 1A and 1B, the band pass filter 100 includes a first pattern 110, second pattern 115, first microstrip line 120, second microstrip line 125, third pattern 130 and ground pattern 140.

As illustrated in FIG. 1A, in a central portion of the band pass filter 100, there is a cross pattern formed by horizontal lines and vertical lines crossing each other. This cross pattern includes horizontal lines of the first pattern 110 and second pattern, and vertical lines of the third pattern 130.

In addition, as illustrated in FIG. 1A, there is a ground pattern 140 at an edge of the band pass filter 100. The ground pattern 140 is arranged to be connected to both ends of the vertical lines of the cross pattern, to be distanced by a certain distance G₂ from the horizontal lines of the cross pattern, and to surround the cross pattern.

In addition, as illustrated in FIG. 1B, the first microstrip line 120 and second microstrip line 125 are arranged to be distanced by a certain distance G₃ from the cross pattern and ground pattern 140.

Furthermore, the first microstrip line 120 is arranged in such a manner that a certain length L₂ area overlaps with an end portion of the first pattern 110 of the horizontal lines in the cross pattern. That is, the first pattern 110 and the first microstrip line 120 are distanced by a certain distance up and down from each other, and overlap each other by a certain length L₂ when seen from a plane view.

In addition, the second microstrip line 125 is arranged in such a manner that a certain length L₂ area overlaps with the other end portion of the second pattern 115 of the horizontal lines in the cross pattern. That is, the second pattern 115 and the second microstrip line 125 are distanced by a certain distance up and down from each other, and overlap each other by a certain length L₂ when seen from a plane view.

In the configuration of FIG. 1A and FIG. 1B, the first pattern 110 and first microstrip line 120 form the first resonator. In addition, the second pattern 115 and second microstrip line 125 form the second resonator. In addition, the third pattern 130 generates a parallel inductance which magnetically combines the first resonator and second resonator.

In addition, as illustrated in FIG. 1A, the third pattern is arranged vertically between the first pattern 110 and second pattern 115. In addition, the ground pattern 140 is connected to the third pattern 130.

In FIG. 1A, the length L₂ area of the first microstrip line 120 which overlaps with the first pattern 110 generates the first inductance. In addition, between the first microstrip line 120 and the first pattern 110, a first capacitance is generated from the overlapped area. The first capacitance is generated because these two metal are distanced by a certain distance G₃. Furthermore, the first pattern 110 generates a second inductance corresponding to the length L₁.

As such, the first pattern 110 and first microstrip line 120 generate the first inductance, first capacitance, and second inductance, and by this, the first resonator is formed.

In FIG. 1A, the length L₂ area of the second microstrip line 125 overlapping with the second pattern 115 generates a third inductance. In addition, between the second microstrip line 125 and second pattern 115, a second capacitance is generated from the overlapped area. The second capacitance is generated because these two metal are distanced by a certain distance G₃. Furthermore, the second pattern 115 generates a fourth inductance corresponding to the length L₁.

As such, the second pattern 115 and second microstrip line 125 generate the third inductance, second capacitance, and fourth inductance, and by this, the second resonator is formed.

As such, in the band pass filter 100 illustrated in FIGS. 1A and 1B, the length of the first pattern 110 or second pattern 115 included in the resonator becomes λ/16 or less. Herein, λ is a wavelength of the transmission signal. As for a signal of a millimeter wavelength band, λ is a millimeter size. As such, the length of the first pattern 110 or second pattern 115 becomes λ/16 or less, and thus the total length of the resonator of the band pass filter 100 becomes λ/8 or less. Accordingly, the size of the band pass filter 100 according to the present exemplary embodiment becomes about 50% smaller than the band pass filter using a conventional λ/4 resonator.

Accordingly, the size of the band pass filter 100 becomes smaller, and a resonator of a single impedance structure having a same impedance is used, thereby enabling easy embodiment of the present disclosure.

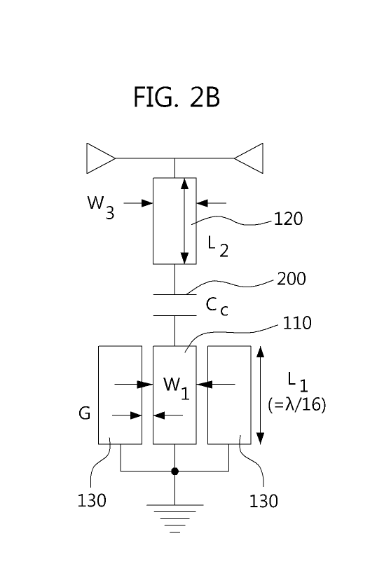

Hereinbelow is explanation of the resonator used in the band pass filter 100 illustrated in FIGS. 1A and 1B in comparison with a conventional resonator, with reference to FIGS. 2A and 2B. FIG. 2A is a view illustrating a conventional resonator. As illustrated in FIG. 2A, a total length of a conventional resonator is λ/4.

FIG. 2B is a view illustrating an equivalent circuit of a resonator used in a band pass filter 100 illustrated in FIGS. 1A and 1B, according to an exemplary embodiment of the present disclosure. As illustrated in FIG. 2B, in the first pattern 110 and first microstrip line 120, the overlapped area forms a capacitor 200 for each other, generating a capacitance Cc.

In addition, in the band resonator according to the present exemplary embodiment, the first pattern 110 and first microstrip line 120 overlap each other, and thus the total length is λ/16.

Furthermore, by the ¼ wavelength resonator of FIG. 2A, a spurious pass band is generated from the frequency band which is three times the base frequency. Meanwhile, in the resonator of 1/16 wavelength or less of FIG. 2B, a spurious pass band is generated from the frequency band which is nine times the base frequency. Accordingly, the resonator of FIG. 2B according to the present exemplary embodiment is enabled to embody a band pass filter 100 having the rejection characteristics of a broadband.

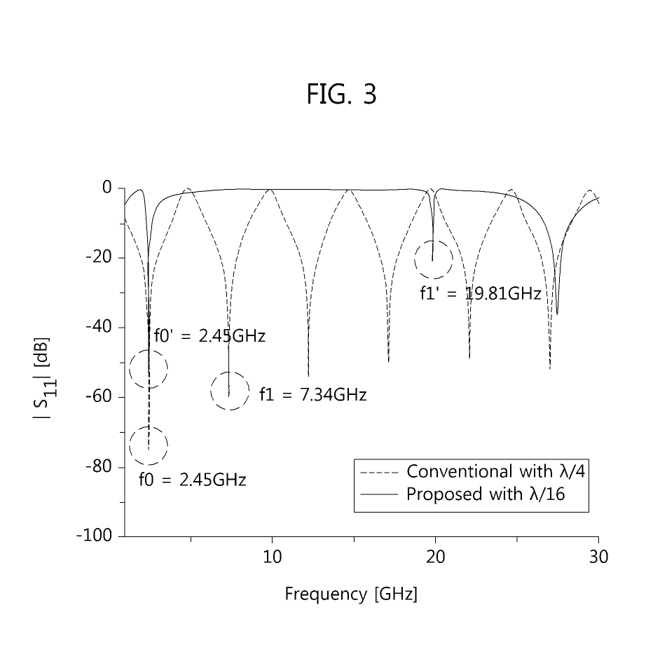

FIG. 3 is a graph comparing frequency characteristics of the resonator of FIGS. 2a and 2b, according to an exemplary embodiment of the present disclosure. One can easily see the difference of the rejection band of the resonator of FIGS. 2A and 2B, through this comparison graph of FIG. 3.

As illustrated in FIG. 3, the base frequency of the resonator of FIGS. 2A and 2B is 2.45 GHz. On the other hand, in a case of using λ/4 resonator of FIG. 2A, the spurious pass band appears in 7.34 GHz, while in a case of λ/16 resonator of FIG. 2B, the spurious pass band appears in 19.81 GHz.

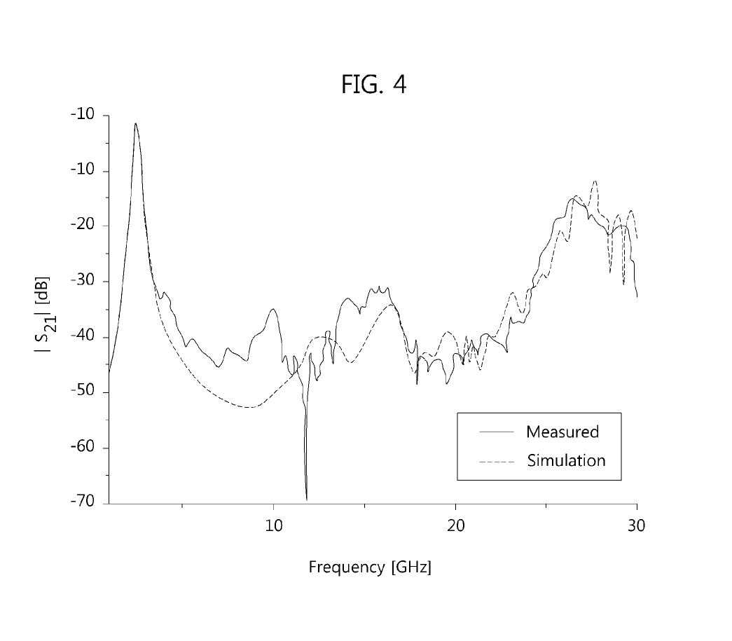

FIG. 4 is a graph illustrating a result of a simulation for checking the broadband rejection characteristics of a band pass filter, according to an exemplary embodiment of the present disclosure. As illustrated in FIG. 4, as a result of measuring the rejection band characteristics of the band pass filter 100, the spurious pass band appeared in the frequency band which is 9.8 times that of the base frequency.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A band pass filter comprising:
a first resonator which includes a first pattern and first microstrip line;
a second resonator which includes a second pattern and second microstrip line;
a third pattern vertically arranged between the first pattern and second pattern; and
a ground pattern connected with the third pattern.

2. The band pass filter according to claim 1, wherein the first resonator is formed in such a manner that the first microstrip line is arranged so that a partial area is overlapped at a certain distance, on the first pattern.

3. The band pass filter according to claim 2, wherein the partial area which overlaps with the first pattern of the first microstrip line generates a first inductance,
a first capacitance is generated between the first microstrip line and first pattern,
the first pattern generates a second inductance, and
a resonator is formed by the first inductance, first capacitance, and second inductance.

4. The band pass filter according to claim 1, wherein the second resonator is formed in such a manner that the second microstrip line is arranged so that a partial area is overlapped at a certain distance, on the second pattern.

5. The band pass filter according to claim 4, wherein the partial area which overlaps with the second pattern of the second microstrip line generates a third inductance,
the second capacitance is generated between the second microstrip line and second pattern,
the second pattern generates a fourth inductance, and
a resonator is formed by the third inductance, second capacitance, and fourth inductance.

6. The band pass filter according to claim 1, wherein the third pattern generates a parallel inductance which magnetically combines the first resonator and second resonator.

7. The band pass filter according to claim 1, wherein each of the first pattern and second pattern is λ/16 (λ being the wavelength of the transmission signal) long.

8. A band pass filter comprising:
a cross pattern formed by horizontal lines and vertical lines crossing each other;
a ground pattern which is connected to both ends of the vertical lines of the cross pattern, distanced at a certain distance from the horizontal lines of the cross pattern, and arranged to surround the cross pattern;
a first microstrip line arranged at a certain distance from the cross pattern and ground pattern, and arranged to overlap with an end of the horizontal lines of the cross pattern; and
a second microstrip line arranged at a certain distance from the cross pattern and ground pattern, and arranged to overlap with the other end of the horizontal lines of the cross pattern.
